(19) United States
(12) Patent Application Publication
(10) Pub. No.: US 2021/0237661 A1
(43) Pub. Date: Aug. 5, 2021

(54) MOBILE DEVICE HOLDER CONFIGURED TO POSITION IN A CUP HOLDER

(71) Applicant: Kuryakyn Holdings, LLC, Somerset, WI (US)

(72) Inventors: Tazio Levi Stefanelli, Downing, WI (US); Anthony Donald Stefanelli, Downing, WI (US); Cory David Kravik, Blaine, MN (US); Joseph Dale Martens, Woodbury, MN (US)

(21) Appl. No.: 16/778,260

(22) Filed: Jan. 31, 2020

(51) Int. Cl. B60R 11/02; H04M 1/04

(52) U.S. Cl. CPC B60R 11/0241; B60R 2011/0007; H04M 1/04

(57) ABSTRACT

A mobile device holder may include a body having a base member with a flexibly resilient wall. A support structure may have a pair of arms that extend outward from the base member. The arms may be configured to move relative to one another between a retracted position and an expended position. Each arm may include an upper flange positioned at an outer end of the arm to retain a mobile device.

### TECHNICAL FIELD

The disclosed embodiments are related to a mobile device holder and, more particularly, to a mobile device holder that rests in a cup holder.

### BACKGROUND

Mobile device holders are often adapted to be retained within a vehicle. The mobile device holder is configured to attached to a portion of the vehicle to allow the mobile device to be held in a position that is visible to a user. In this position, the user may activate the mobile device while operating the vehicle, for example, to check a map operated by a global positioning system in the mobile device. It is desirable to retain the mobile device in an area of the vehicle that does not limit the users field of vision. For example, the mobile device may be retained near a cup holder of the vehicle. Unfortunately, many mobile device holders occupy the space within the cup holder so that the cup holder becomes unuseable.

### SUMMARY

In a first aspect of the disclosed embodiments, a mobile device holder may include a body. The body may include a base member having a flexibly resilient wall and a tab extending outward from the flexibly resilient wall. The body may also include a support structure having a pair of arms that extend outward from the base member. The arms may be configured to move relative to one another between a retracted position and an expended position. Each arm may include an upper flange positioned at an outer end of the arm. The arms may be configured to move into the expanded position to receive a mobile device. The arms may move back toward the retracted position to retain the mobile device between the upper flanges of each arm.

In some embodiments of the first aspect, the flexibly resilient wall may be substantially arcuate. The flexibly resilient wall may be moveable between an expanded position and a retracted position to size the flexibly resilient wall for insertion into a cavity. The flexibly resilient wall may define an opening. The tab may extend into the opening.

Optionally, in the first aspect, each upper flange may include a first segment extending outward from the respective arm. A second segment may extend inward from the first segment to define a notch. The mobile device may be retained in the notch. A lower flange may extend from an inner end of each arm to retain a base of the mobile device. Each lower flange may extend in a direction along a length of the arm to define a notch between the lower flange and the respective arm. The base of the mobile device may be retained in the notch.

It may be desired in the first aspect that, in the retracted position, the pair of arms may extend substantially parallel to one another. In the expanded position, the pair of arms may extend at a non-orthogonal angle relative to one another. The arms may be positioned in an intermediate position between the expanded position and the retracted position the retain the mobile device. Each arm may include a tab extending from the arm to define a notch. The notch of both arms may receive a fastening mechanism to secure the mobile device to the arms.

In some embodiments of the first aspect, the base member and the support structure may be integrally formed. The base member and the support structure may include nylon. A retention slot may be positioned between the pair of arms. The tab may be weighted.

In a second aspect of the disclosed embodiments, a mobile device holder may include a body. The body may include a base member having a substantially arcuate flexibly resilient wall that is moveable between an expanded position and a retracted position. The body may also include a support structure having a pair of arms that extend outward from the base member. The arms may be configured to move relative to one another between a retracted position and an expended position. Each arm may include an upper flange positioned at an outer end of the arm to define an upper notch and a lower flange extending from an inner end of each arm to define a lower notch.

In some embodiments of the second aspect, the flexibly resilient wall may retract to size the flexibly resilient wall for insertion into a cavity. Each upper flange may include a first segment extending outward from the respective arm. A second segment may extend inward from the first segment to define the upper notch.

Optionally, in the second aspect, in the retracted position, the pair of arms may extend substantially parallel to one another. In the expanded position, the pair of arms may extend at a non-orthogonal angle relative to one another. Each arm may include a tab extending from the arm to define a rear notch. The rear notch of both arms may receive a fastening mechanism to secure the mobile device to the arms.

In some embodiments of the second aspect, the base member and the support structure may be integrally formed. A tab may extend outward from the flexibly resilient wall. A retention slot may be positioned between the pair of arms. The tab may be weighted.

### BRIEF DESCRIPTION OF THE DRAWINGS

The concepts described in the present disclosure are illustrated by way of example and not by way of limitation in the accompanying figures. Where considered appropriate, reference labels have been repeated among the figures to indicate corresponding or analogous elements. The detailed description particularly refers to the accompanying figures in which:

FIG. 1 is a front perspective view of a mobile device holder in accordance with an embodiment;

FIG. 2 is a front perspective view of the mobile device holder of FIG. 1 with the arms in an extended position;

FIG. 3 is a front perspective view of the mobile device holder of FIG. 1 with the arms in an intermediate position and retaining a mobile device;

FIG. 4 is a top plan view of a fastening mechanism in accordance with an embodiment;

FIG. 5 is a side perspective view of the fastening mechanism of FIG. 4 attached to the mobile device holder of FIG. 1;

FIG. 6 is a front perspective view of the fastening mechanism of FIG. 4 retaining a mobile device on the mobile device holder of FIG. 1; and

FIG. 7 is a front perspective view of the mobile device holder of FIG. 1 with the flexibly resilient wall in a retracted position.

### DETAILED DESCRIPTION OF THE DRAWINGS

While the concepts of the present disclosure are susceptible to various modifications and alternative forms, specific embodiments thereof have been shown by way of example in the figures and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

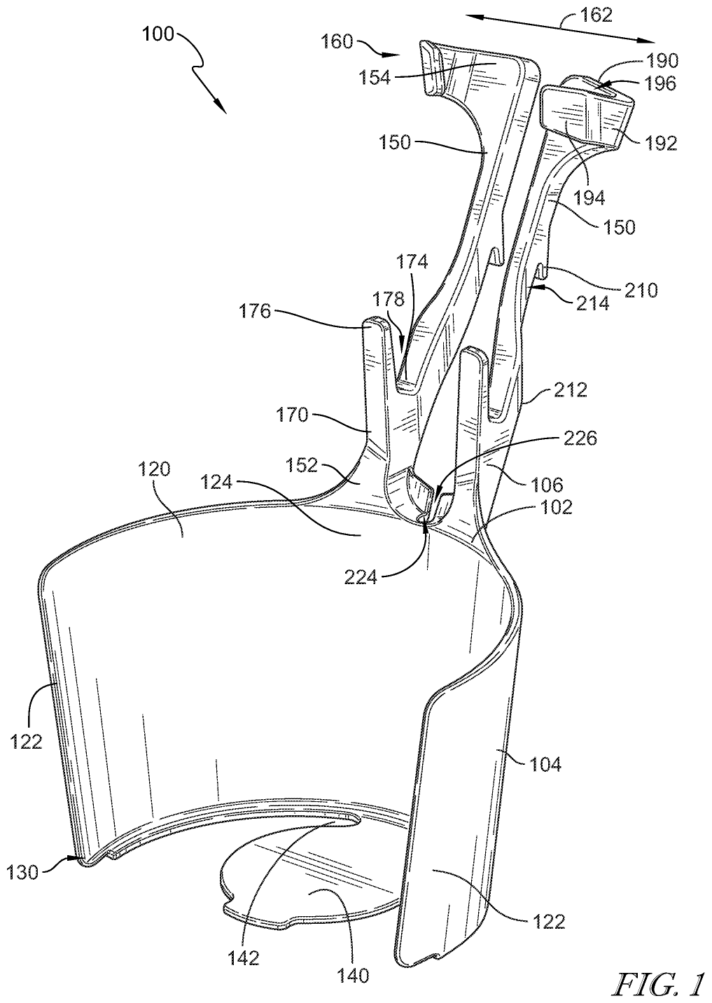

Referring to FIG. 1, a mobile device holder 100 includes a body 102 having a base member 104 and a support structure 106. The base member 104 and the support structure 106 are integrally formed as a unitary body 102, in some embodiments. In other embodiments, the base member 104 and the support structure 106 may be separately formed and joined together. In an exemplary embodiment, the body 102 is formed from nylon so that the base member 104 and the support structure 106 may be flexed and deformed. In other words, the body 102 is flexibly resilient to moves and return to its original form with no external action. In other embodiments, the body 102 may be formed from another material that is flexibly resilient and deformable.

The base member 104 is configured to be inserted into a cavity, for example, a cup holder of a vehicle. The base member 104 includes a substantially arcuate flexibly resilient wall 120 having a pair of flanges 122 extending outward from a center 124. The flanges 122 extends outward from the flexibly resilient wall 120 to define an opening 126 between the flanges 122. The flexibly resilient wall 120 is movable from an expanded position 130, shown in FIG. 1, to a retracted position 132, shown in FIG. 7, to size the base member 104 for insertion into the cavity. That is, the flanges 122 are curled inward, toward the opening 126, in the retracted position 132, to reduce an outer circumference of the flexibly resilient wall 120, so that the base member 104 is insertable into the cavity. With the base member 104 inserted into the cavity, the flexibly resilient wall 120 is released back to its original size to position the flanges 122 of the flexibly resilient wall 120 against a wall of the cavity. The flexibly resilient wall 120 pushes against the wall of the cavity to secure the base member 104 in the cavity. In this position, a beverage container may be positioned in the cavity, while the device 100 is positioned in the cavity.

The base member 104 also includes a tab 140 that extends outward from the flexibly resilient wall 120. The tab 140 extends from a bottom 142 of the flexibly resilient wall 120 into the opening 126 defined between the flanges 122. When the base member 104 is positioned within the cavity, the tab 140 is positioned on a bottom of the cavity. The tab 140 balances the base member 104 within the cavity. When a beverage container is positioned in the cavity, the beverage container rests on top of the tab 140 to provide additional support to the device 100. In some embodiments, the tab 140 may be weighted to assist in balancing the device 100 within the cavity.

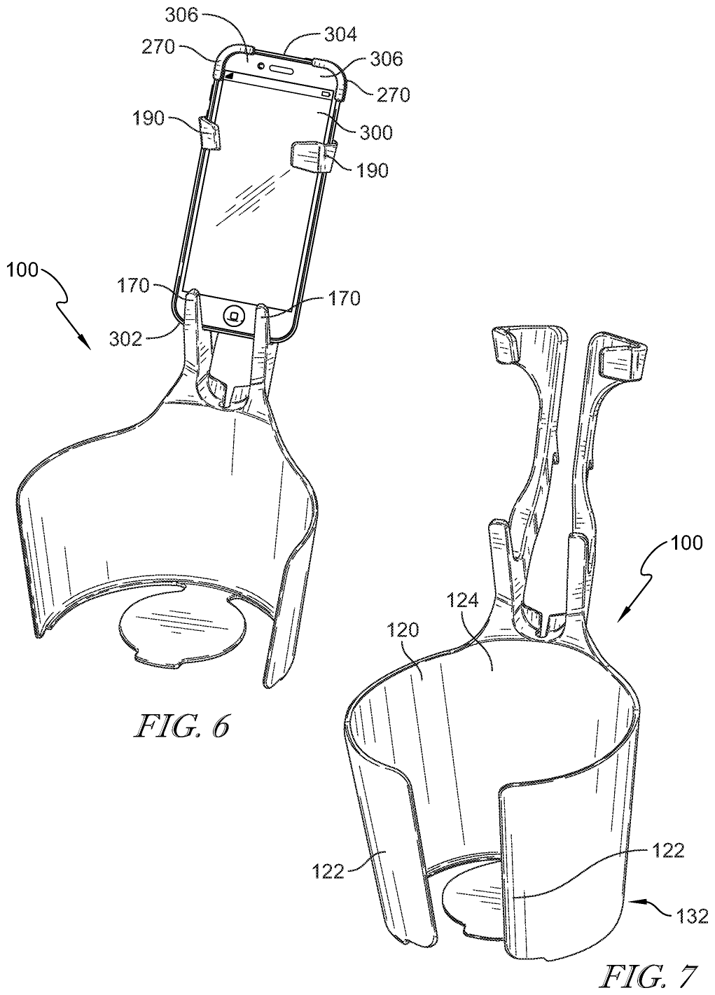

The support structure 106 is configured to retain a mobile device 300, for example, a mobile phone, shown in FIGS. 3 and 6, while the device 100 is positioned in the cavity. The support structure 106 is capable is retaining the mobile device 300 while a beverage container is positioned in the cavity. The support structure 106 includes a pair of arms 150 that extend outward from the base member 104. The arms 150 extend from an inner end 152 to an outer end 154. In a retracted position 160, shown in FIG. 1, the arms 150 are positioned substantially parallel to one another, in one embodiment. In the retracted position 160, the outer ends 154 of the arms 150 are positioned a distance 162 from one another.

A lower flange 170 extends from a front 172 of each arm 150. The lower flange 170 extends from the inner end 152 of each arm 150. Each lower flange 170 includes a base segment 174 that extends forward from the arm 150. A front segment 176 extends from the base segment 174 in a direction along a length of the arm 150 to define a lower notch 178 between the lower flange 170 and the respective arm 150. A base 302 of the mobile device 300 is configured to position and be retained in the lower notch 178.

An upper flange 190 extends from the front 172 of each arm 150. The upper flange 190 extends from the outer end 154 of each arm 150. Each upper flange 190 includes a base segment 192 that extends from the arm 150. A front segment 194 extends from the base segment 192 in a direction along the front 172 of the respective arm 150 to define an upper notch 196 between the upper flange 190 and the respective arm 150. An upper portion 304 of the mobile device 300 is configured to position and be retained in the upper notch 196.

A rear flange 210 extends from a rear 212 of each arm 150. The rear flange 210 is position along the length of the arm 150 between the lower flange 170 and the upper flange 190. Each rear flange 210 extends downward from the arm 150 to define a rear notch 214. The rear notch 214 is configured to retain a fastening mechanism 220, as shown in FIG. 4 and described in more detail below.

The mobile device holder 100 also includes a retention slot 224 positioned between the pair of arms 150. The retention slot 224 extends from an opening 226 formed between the inner ends 152 of each arm 150 and into the body 102. The retention slot 224 is sized to retain a cord or wire of a charging device (not shown). That is, when the mobile device 300 is positioned in the mobile device holder 100, a first plug of the charging device may be coupled to an input of the mobile device 300. The cord or wire of the charging device may then be positioned in the retention slot 224 so that a second, opposite plug of the charging device may be inserted into an input of the vehicle.

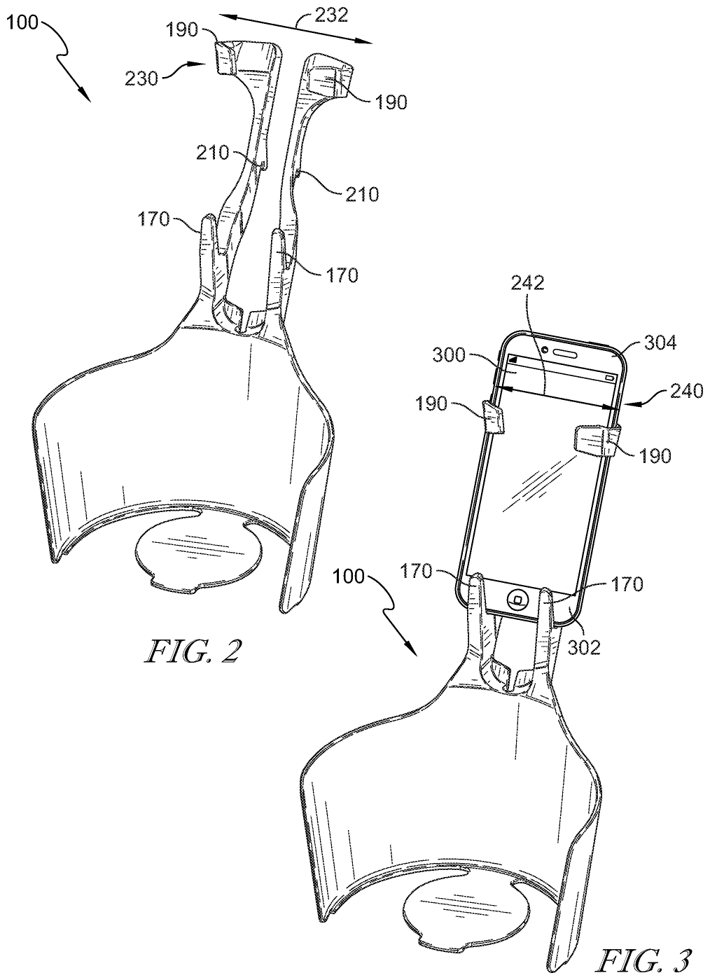

Referring now to FIG. 2, the arms 150 are flexibly resilient and moveable in an outward direction. That is, the arms 150 flex outward away from one another and return to their original position without external force. The arms 150 flex outward to an expanded position 230, wherein the arms 150 are positioned a distance 232 from one another. More particularly, the outer ends 154 of the arms 150 are positioned the distance 232. The distance 232 is greater than the distance 162. In the expanded position 230, the arms 150 are spaced a sufficient distance for the mobile device 300 to be positioned between the upper flanges 190. The base 302 of the mobile device 300 can then be positioned in the lower notches 178 of the arms 150. With the base 302 of the mobile device 300 positioned in the lower notches 178 the arms 150 can be released so that the arms 150 move back toward the retracted position 160. As the arms 150 move back toward the retracted position 160, the upper end 304 of the mobile device 300 is captured in the upper notches 196 of the arms 150 at an intermediate position 240, shown in FIG. 3, that is between the retracted position 160 and the expanded position 230. In the intermediate position 240, the outer ends 154 of the arms 150 are position a distance 242 that is less than the distance 232 and greater than the distance 162. Thus, the mobile device 300 is held within the lower notched 178 and the upper notches 196. The arms 150 push against the mobile device 300 to secure the mobile device 300 within the upper notches 196.

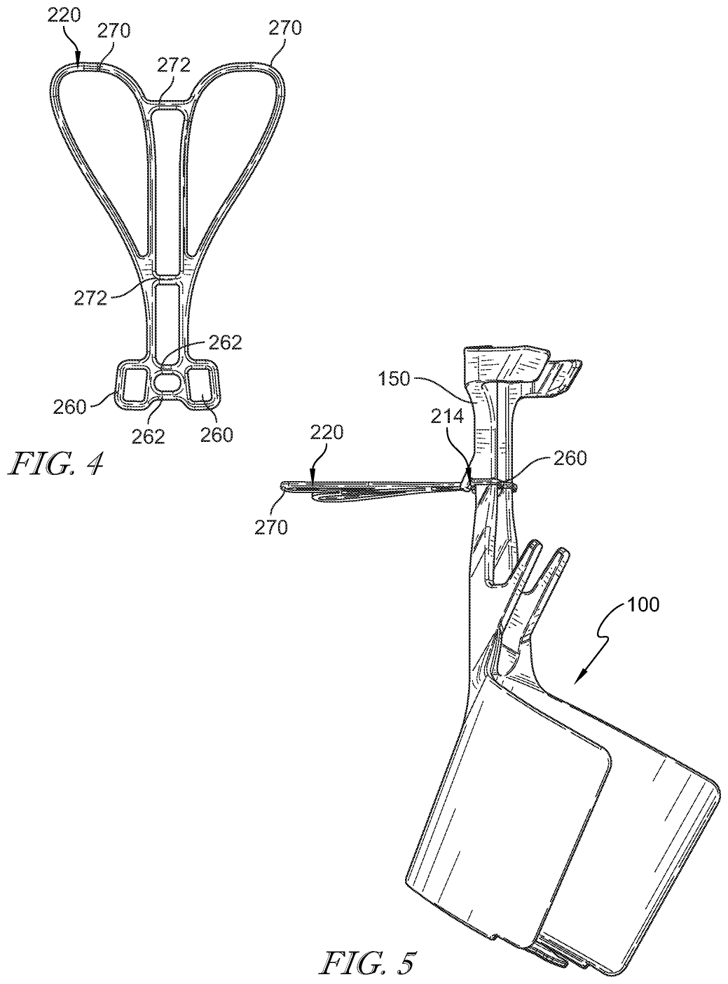

Referring to FIG. 4, the fastening mechanism 220 may be optionally used with the device 100 to provide additional retention for the mobile device 300. For example, the fastening mechanism 220 may be utilized when the device 100 is used with an off-road vehicle. The fastening mechanism 220 is configured to position in the rear notches 214 of each arm 150. The fastening mechanism 220 includes lower loops 260 that expand to slide over the arms 150. The lower loops 260 are joined by intermediate sections 262. The lower loops 260 are slid along the length of the arms 150 and secured within the rear notches 214, as shown in FIG. 5. The intermediate sections 262 are flexibly resilient and expandable so that the arms 150 may be move between the retracted position 160 and the expanded position 230 with the fastening mechanism 220 secured to the arms 150.

A pair of upper loops 270 are joined to the lower loops 260 by intermediate sections 272. When the mobile device 300 is secured within the device 100, the upper loops 270 are pulled around the corners 306 of the mobile device 300. The intermediate sections 272 are flexibly resilient and expand to enable the upper loops 270 to wrap around the corners 306 of the mobile device 300, as shown in FIG. 6, to provide additional retention for the mobile device 300.

While certain illustrative embodiments have been described in detail in the figures and the foregoing description, such an illustration and description is to be considered as exemplary and not restrictive in character, it being understood that only illustrative embodiments have been shown and described and that all changes and modifications that come within the spirit of the disclosure are desired to be protected. There are a plurality of advantages of the present disclosure arising from the various features of the methods, systems, and articles described herein. It will be noted that alternative embodiments of the methods, systems, and articles of the present disclosure may not include all of the features described yet still benefit from at least some of the advantages of such features. Those of ordinary skill in the art may readily devise their own implementations of the methods, systems, and articles that incorporate one or more of the features of the present disclosure.

1. A mobile device holder comprising:
a body, wherein the body includes:
a base member having a flexibly resilient wall and a tab extending outward from the flexibly resilient wall, wherein the flexibly resilient wall is moveable between an expanded position and a retracted position to size the flexibly resilient wall for insertion into a cavity, and
a support structure having a pair of arms that extend outward from the base member, the arms being configured to move relative to one another between a retracted position and an expanded position, wherein in the expanded position the pair of arms extend at a non-orthogonal angle relative to one another, wherein each arm includes an upper flange positioned at an outer end of the arm, wherein the arms are configured to move into the expanded position to receive a mobile device, wherein the arms move back toward the retracted position to retain the mobile device between the upper flanges of each arm.

2. The mobile device holder of claim 1, wherein the flexibly resilient wall is arcuate.

3. The mobile device holder of claim 1, wherein the flexibly resilient wall defines an opening, the tab extending into the opening.

4. The mobile device holder of claim 1, wherein each upper flange includes:
a first segment extending outward from the respective arm; and
a second segment extending inward from the first segment to define a notch,
wherein the mobile device is retained in the notch.

5. The mobile device holder of claim 1, further comprising a lower flange extending from an inner end of each arm to retain a base of the mobile device.

6. The mobile device holder of claim 5, wherein each lower flange extends in a direction along a length of the arm to define a notch between the lower flange and the respective arm, wherein the base of the mobile device is retained in the notch.

7. The mobile device holder of claim 1, wherein, in the retracted position, the pair of arms extends parallel to one another.

8. The mobile device holder of claim 1, wherein the arms are positioned in an intermediate position between the expanded position and the retracted position the retain the mobile device.

9. The mobile device holder of claim 1, wherein each arm includes a tab extending from the arm to define a notch, wherein the notch of both arms receives a fastening mechanism to secure the mobile device to the arms.

10. The mobile device holder of claim 1, wherein the base member and the support structure comprise nylon and are integrally formed.

11. The mobile device holder of claim 1, further comprising a retention slot positioned between the pair of arms.

12. The mobile device holder of claim 1, wherein the tab is weighted.

13. A mobile device holder comprising:
a body, wherein the body includes:
a base member having a flexibly resilient wall that is moveable between an expanded position and a retracted position to size the flexibly resilient wall for insertion into a cavity, and
a support structure having a pair of arms that extend outward from the base member, the arms being configured to move relative to one another between a retracted position and an expanded position, wherein in the expanded position the pair of arms extend at a non-orthogonal angle relative to one another, wherein each arm includes an upper flange positioned at an outer end of the arm to define an upper notch and a lower flange extending from an inner end of each arm to define a lower notch.

14. The mobile device holder of claim 13, wherein each upper flange includes:
a first segment extending outward from the respective arm; and
a second segment extending inward from the first segment to define the upper notch.

15. The mobile device holder of claim 13, wherein, in the retracted position, the pair of arms extends parallel to one another.

16. The mobile device holder of claim 13, wherein each arm includes a tab extending from the arm to define a rear notch, wherein the rear notch of both arms receives a fastening mechanism to secure the mobile device to the arms.

17. The mobile device holder of claim 13, wherein the base member and the support structure are integrally formed.

18. The mobile device holder of claim 13, further comprising a tab extending outward from the flexibly resilient wall.

19. The mobile device holder of claim 13, further comprising a retention slot positioned between the pair of arms.

20. The mobile device holder of claim 13, wherein a weighted tab extends outward from the flexibly resilient wall.
